(19) United States
(12) Patent Application Publication
(10) Pub. No.: US 2001/0027420 A1
(43) Pub. Date: Oct. 4, 2001

(54) Method and apparatus for capturing transaction data

(76) Inventors: Miroslav Boublik, San Carlos, CA (US); Poulomi Damany, Redwood City, CA (US)

Correspondence Address: LAW OFFICES OF JONATHAN ALAN QUINE, P O BOX 458, ALAMEDA, CA, 94501

(21) Appl. No.: 09/747,297

(22) Filed: Dec. 21, 2000

Related U.S. Application Data
(60) Provisional application No. 60/171,826, filed on Dec. 21, 1999.

(51) Int. Cl. G06F 17/60

(52) U.S. Cl. 705/26

(57) ABSTRACT

A method or system for determining extracting relevant information from a browser or similar application utilized by a user computing device is provided.

### FIELD OF THE INVENTION

The present invention is related to the field of data processing and computer systems. More specifically, the present invention is directed to a method and/or system for automating portions of the tasks typically required for business transactions using a computer system.

### BACKGROUND OF THE INVENTION

At present there is a great deal of interest in using public data networks, such as the internet, to facilitate business transaction tasks, such as ordering or purchasing goods or services. A large number of businesses and strategies have been proposed for business-to-business; business-to-consumer; and even consumer-to-consumer transactions using the Internet.

Many commentators have noted that businesses as purchasers, particularly small businesses as purchasers, have not been fully served by internet commerce paradigms. Interviews with small businesses reveal that manual data entry of accounts payable data into accounting packages is one of the least productive and most unpleasant uses of their time. This bookkeeping inefficiency exists even in online procurement, because after ordering on-line, small businesses generally must manually re-key online transaction data into a financial application, such as a local accounting package. The inventors of the present invention have estimated that small businesses spend anywhere from $5,000-$44,000 each year (estimated at 180-2000 hrs/yr. spent on data re-entry of online purchases at an average bookkeeper hourly rate of $22) performing this data re-entry. This is an aggregate of approximately $18 billion wasted annually by U.S. small businesses. Interviews with a number of small businesses have indicated a strong willingness to pay for elimination of manually reentering data generated by online procurement.

Furthermore, manual data re-entry is often done by a hired bookkeeper or by a business owner on a weekly or monthly basis. The time delay in data entry means that the business does not have an accurate, up-to-date picture of the cash outflow, a critical component of managing a small business.

What is needed is a method and system for removing this painful step of data re-entry for the small businesses where possible when conducting transactions online.

Some sites have attempted to meet some needs of small business owners and to automate some tasks associated with procurement. These include: Works.com, OnVia.com., Staples.com, BuyersZone, etc.

### SUMMARY

According to one embodiment of the invention, for a user interacting with an online procurement site, the invention provides added functionality allowing the user to have transaction data automatically entered into a user's financial application. Various embodiments can interact with either local applications or soon to be available “web-based” applications.

Another embodiment of the present invention allows for the intelligent parsing of information contained in one more documents or pages generated in markup language such as HTML, XML, or the like.

In a further embodiment the present invention allows for the identification of specific internet web pages by utilizing either a uniform resource locator, pre-determined content, or both to determine whether the specific internet web page is a page of interest for the user.

In yet another embodiment the present invention allows for the parsing of information from documents by selecting information having a predetermined distance from other information on the document. According to specific embodiments of the present invention, the invention includes the flexibility to capture information regarding a transaction even where that information is spread over a number of different user-interface pages or web pages.

The invention will be better understood with reference to the following drawings and detailed description. For purposes of clarity, this discussion refers to devices, methods, and concepts in terms of specific examples. However, the method of the present invention may operate within a variety of types of logical devices. It is therefore intended that the invention not be limited except as provided in the attached claims.

Furthermore, it is well known in the art that logic systems can include a wide variety of different components and different functions in a modular fashion. Different embodiments of a system can include different mixtures of elements and functions and may group various functions as parts of various elements. For purposes of clarity, the invention is described in terms of systems and methods that include many different innovative components and innovative combinations of components. No inference should be taken to limit the invention to combinations containing all of the innovative components listed in any illustrative embodiment in this specification.

All publications, patents, and patent applications cited or listed herein are hereby incorporated by reference in their entirety for all purposes.

### BRIEF DESCRIPTION OF THE DRAWINGS

FIG. 1 illustrates an overview data flow diagram of ordering according to a specific embodiment of the invention.

FIG. 2 illustrates a block diagram of underlying technologies according to an embodiment of the present invention.

FIG. 3 illustrates a confirmation screen according to an embodiment of the invention.

FIG. 4 illustrates a field parsing confirmation screen according to an embodiment of the present invention.

FIG. 5 illustrates a template mapper according to an embodiment of the present invention.

FIG. 6 illustrates the process of saving data for import into a financial application according to an embodiment of the present invention.

FIGS. 7A-D are flow charts indicating methods according to various specific embodiments of the present invention.

FIG. 8 illustrates an example high level architecture according to an embodiment of the invention.

FIG. 9 illustrates an alternative example high level architecture according to an embodiment of the invention.

FIG. 10 illustrates an example process for capturing and parsing information from one or more addressed documents according to the present invention.

FIG. 11 illustrates an example process for determining start and stop pages according to an embodiment of the present invention.

FIG. 12 illustrates an example process for determining whether one or more addressed documents are relevant according to specific embodiments of the present invention.

FIG. 13 illustrates an example process for parsing according to specific embodiments of the present invention.

FIG. 14 illustrates a process for learning how to parse previously unparsed document addresses according to present invention.

FIG. 15 illustrates an example logic processing device, components of which may embody various aspects of the present invention.

### DESCRIPTION OF SPECIFIC EMBODIMENTS

Various functions and aspects of specific embodiments of the present invention will now be discussed.

Example System Overview

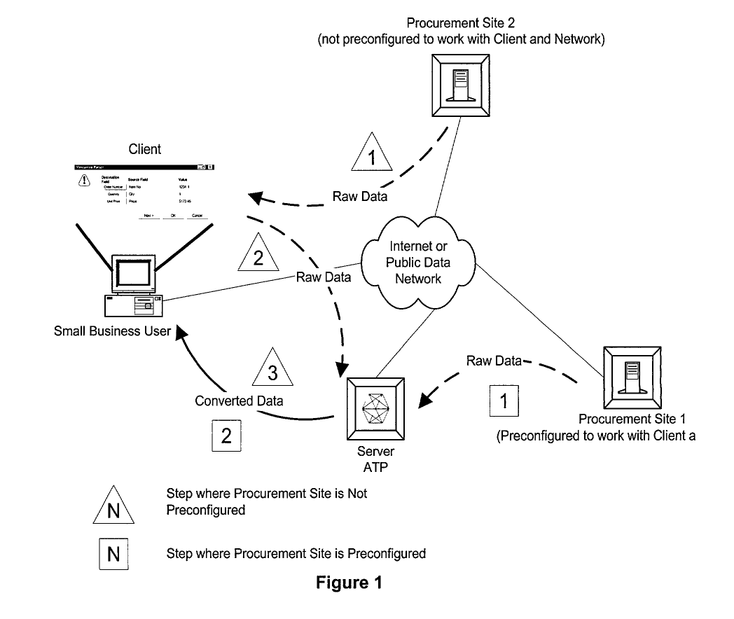

FIG. 1 illustrates an overview data flow diagram of ordering according to a specific embodiment of the invention. According to a specific example embodiment, the present invention may be embodied into a computerized system or method comprising a server side component and a client side component.

The server-side component performs one or more of the following functions: (1) connects directly to procurement sites and/or to the desktop client on the user's machine, (2) collects relevant information, (3) converts it to accounting package format and (4) stores it for future downloads and analysis.

In a further embodiment, a client side component simplifies user interaction and captures data from sites that are not directly connected to the server. In specific embodiments, using the client, users can more easily manage various financial management tasks.

In an alternative embodiment, the method and server side component of the invention can be invoked even when a purchaser does not have a client installed on their system by having a procurement site detect that a transaction is taking place and perform some of the data capture functions.

Server Side Overview

According to one specific embodiment of the invention, an analysis, parser, or “server” side component may be understood as an XML-based exchange system. This system provides elements for user authentication, guaranteed messaging and data delivery, data conversion, real-time data analysis, etc.. FIG. 9 illustrates an alternative example high level architecture according to an embodiment of the invention. This figure shows various components of a server-side system according to an embodiment.

Authentication and Encryption Envelope

According to specific embodiments, the present invention provides two levels of authentication: one for the online service providers (e.g. the procurement sites), and the other for end users. Furthermore, each user is likely to have user accounts on multiple procurement sites, thus necessitating one-to-many authentication relationships between the invention and procurement sites. A robust LDAP server will provide end user authentication and authorization services, while a certificate server will authenticate procurement sites.

Public Key Infrastructure (PKI)-based Virtual Private Network (VPN) or similar schemes may be used to encrypt the basic data “pipe” between the system and each procurement site. These VPN tunnels are erected dynamically when a link is established from the procurement site to the present invention.

Guaranteed Messaging Bus

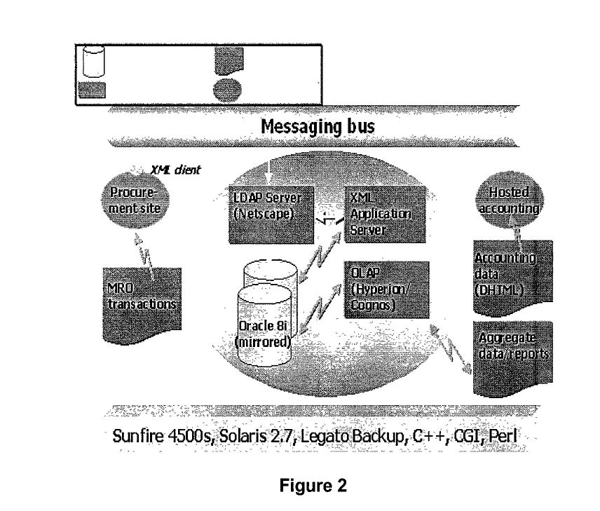

Given the importance of the data carried by the present invention, in one embodiment, the platform guarantees delivery of each transaction record from each procurement site to the aggregator and to end users. In one embodiment, this component is incorporated into the system as shown in FIG. 2. A dual queuing mechanism will assure that a message is delivered despite potential system slow-downs and outages.

In addition, a publish-and-subscribe service is used to deliver real-time market information from the aggregator to the procurement sites.

Application Services Management

An ASM is used to Maintain session integrity and provide persistency, load balancing and fault tolerant capabilities. The application server provides session persistence, load balancing, session monitoring and cross-platform interoperability.

Data Conversion Engine

Data conversion can be delivered through a stand-alone element or it can be implemented as a logic element within the application server's business logic.

Monitoring and Management Tools

Both the server platform and the procurement site client provide remote monitoring and management capability. In addition, both services operate from within an enterprise management platform such as HP OpenView and can use SNMP as the underlying management technology.

Client Side Overview

According to specific embodiments, the present invention can assist purchasers in capturing purchase information with little or no involvement of any particular shopping site. To accomplish this, according to specific embodiments of the present invention, purchases have active on their system a monitoring logic module that can detect when a purchaser connects to a particular business site of interest. According to specific embodiments of the present invention, this logic module (1) detects the start page or start data of a user transaction of interest; (2) detects the stop page or data of a transaction of interest; and (3) forwards pages regarding a transaction of interest to a parser to determine data values of interest for an accounting package. According to specific embodiments of the present invention, all of these activities can be performed without specific participation or cooperation of the selling website. A parser according to specific embodiments of the present invention can be located at the same machine as the monitor or located at a distant machine to which the monitor module sends the captured transaction pages.

Smart Monitoring

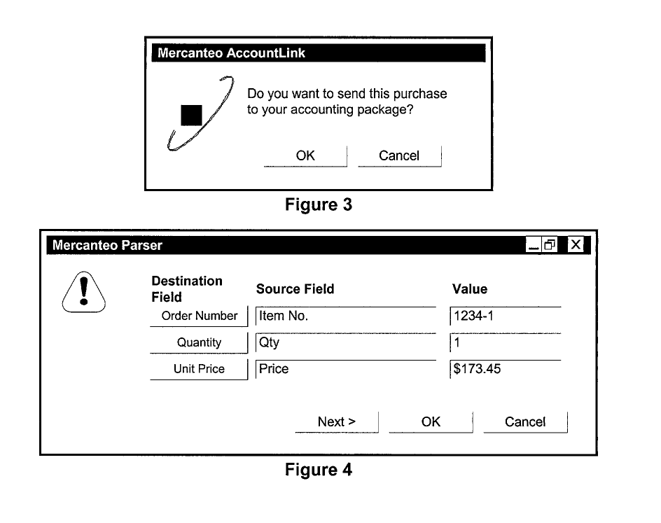

According to specific embodiments of the present invention, to capture online buying transactions, client monitor logic monitors all browser traffic for transaction data. When shopping cart-type data (e.g. price, quantity, etc.) or other data indicating a buying transaction or a particular URL is detected, according to specific embodiments of the present invention, a client monitor can initiate a message box, such as the example shown in FIG. 3, and ask the user if they wish to download the transaction into accounting format. According to further specific embodiments of the present invention, this request can be disabled and the capturing activity can take place automatically as indicated by user settings.

Parsing

Once a shopping cart page or other transaction page or pages is detected and present at the parser, a parser checks if a template exists for that site and uses that template to parse the data. If a template does not exist, a parser looks for common tags (e.g. qty, price) and makes an attempt to parse the data. According to specific embodiments of the present invention, this data can then be presented on screen in the template mapper for the user to modify, an example of which is shown in FIG. 4.

Drag and Drop Field Mapping Graphical Template Mapping

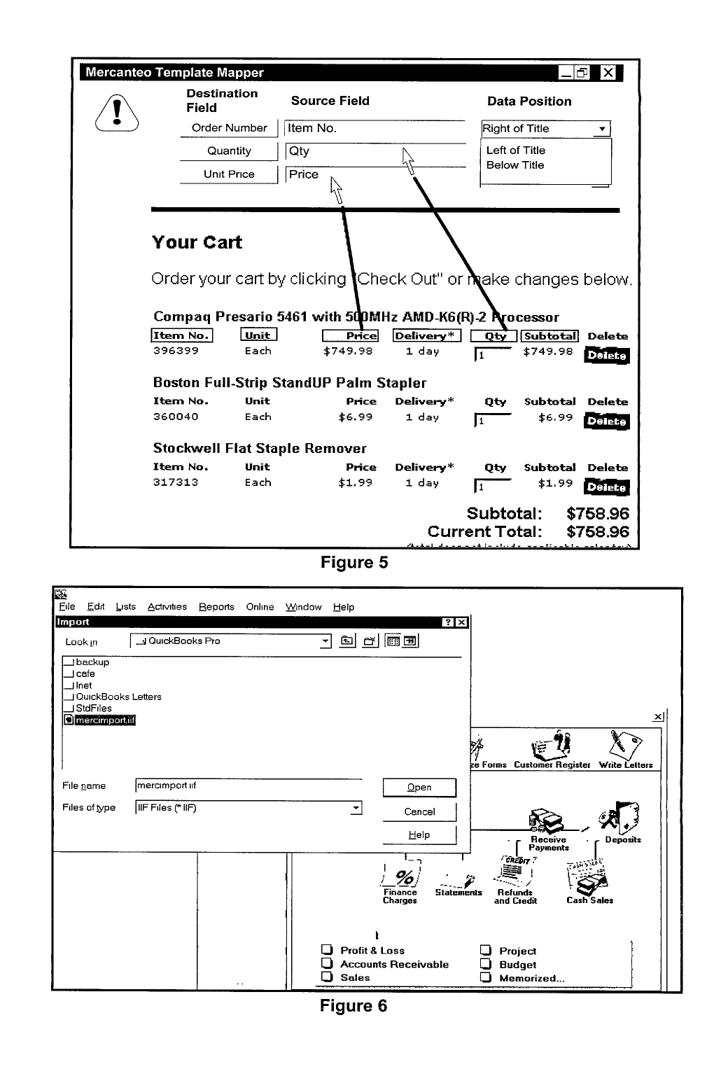

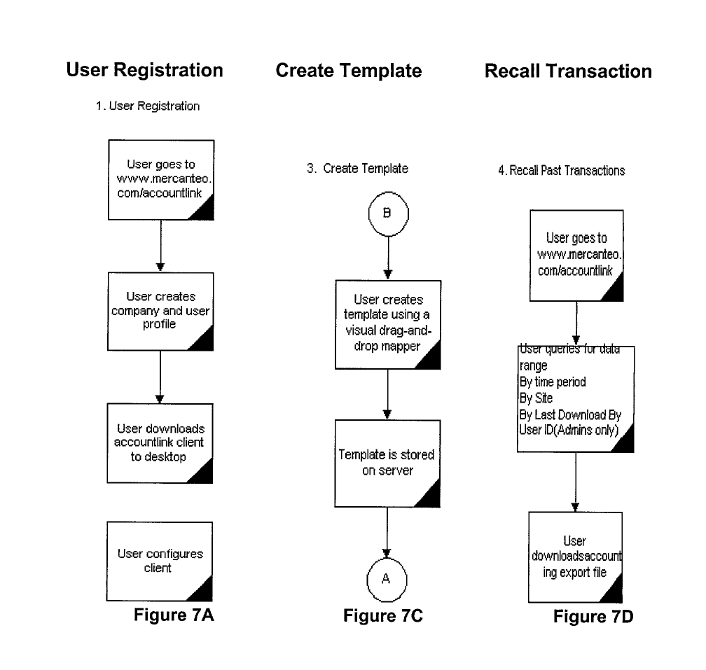

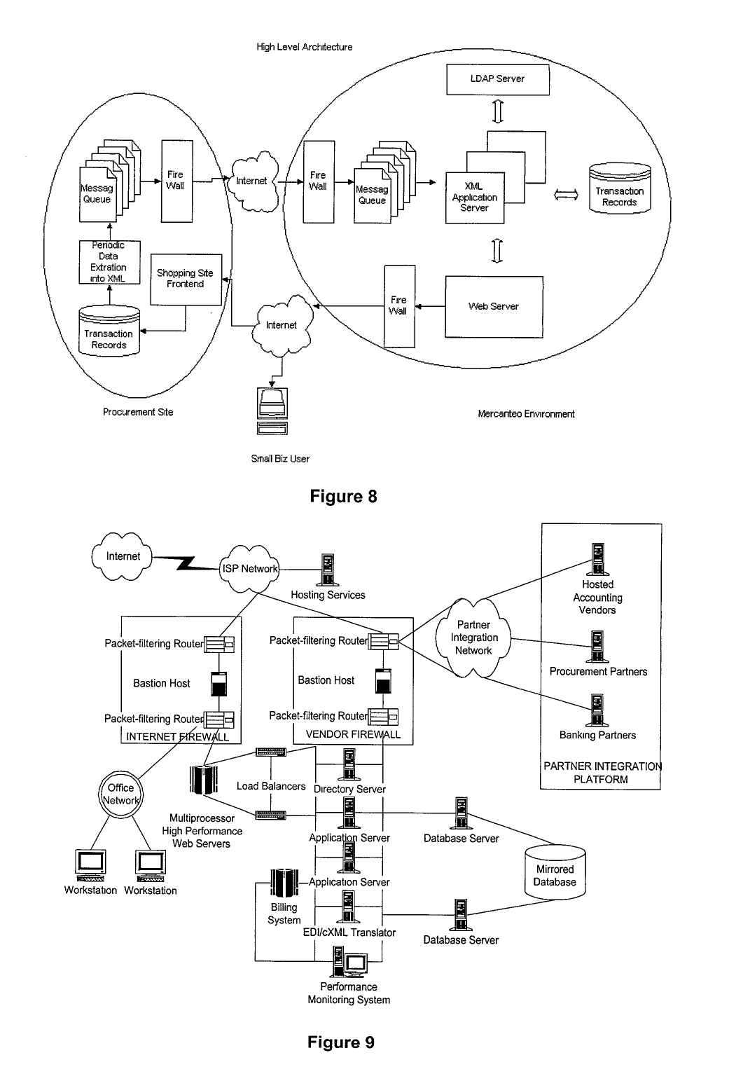

FIG. 5 illustrates a template mapper according to an embodiment of the present invention. According to one embodiment an end user and/or template designer is able to drag and drop fields from the shopping cart page to the template mapper. The template mapper contains a list of required fields and allows the user to associate this data to the fields on the shopping cart page graphically. The user selects the source (shopping cart) field name and drops it into the destination template field name to form the association. The user also provides the source position (left/ right/ below the field name) of the data associated with that field. When completed and verified, according to specific embodiments of the present invention, a site template can be made available globally for all future users who buy from a particular detected purchase site.

Data Backup & Security

Once shopping data is successfully parsed, it can be stored in a database for user access or otherwise be made available to a user. After storage, the data is available to the user for subsequent recall and retrieval. In one embodiment, the data is transmitted as a secure XML document.

Multiple Accounting File Formats

Based on a user profile on the server, a logic module according to specific embodiments of the present invention, will generate data that may be imported to a desired financial application, such as an accounting application. According to specific embodiments, the present invention can generate an ASCII file whose format is compatible with the import file format of the accounting package preferred by the user. Supported accounting packages, for example, can include Quickbooks™, Peachtree™, Great Plains™, MAS90™ and M.Y.O.B™. Online accounting packages like NetLedger and WebGL may also be supported. This data may then be automatically imported into the user's accounting package and a confirmation of the operation will be sent to the server.

User Hierarchy & Authentication

According to specific embodiments of the present invention, a user profile can be created at the time of a registration with a parser site and will allow a hierarchy among users belonging to one company. One account with administrator level privileges can be defined and that account will be responsible for assigning ids for additional employees of the same company. Each user will have a unique id and password, which will be used to authenticate them when they send data to the server or query information from the server. The user will have the option of saving the id-password pair in a cookie on the user desktop after the first login, to enable automatic login for subsequent access.

According to one embodiment of the invention, Java® is the primary development tool. Java was chosen because developers are trained and available and there are many plug-ins and off-the-shelf components that are available in the market to provide some of the functionality desired. However, other development environments as known in the art could be used to implement the invention.

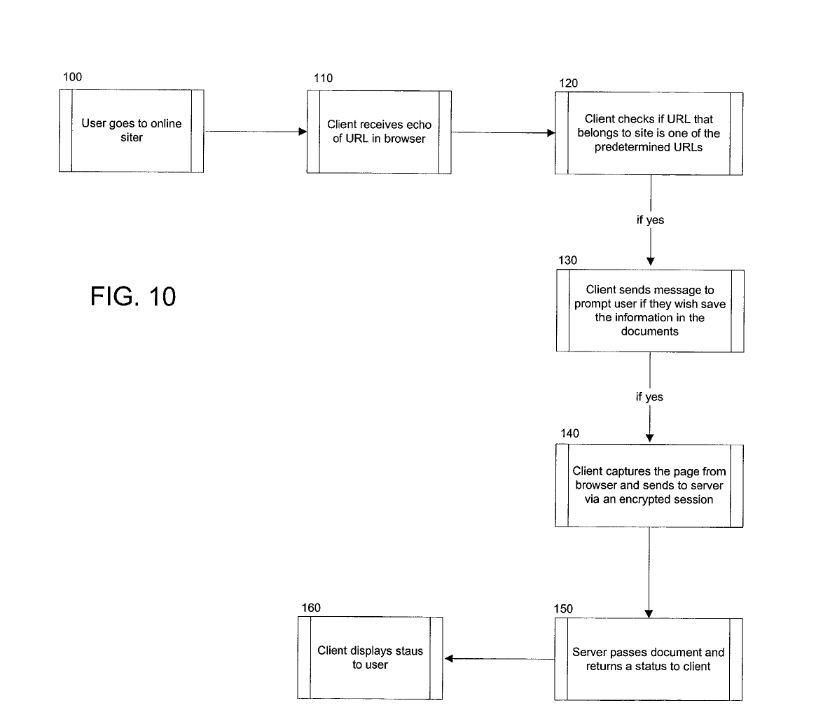

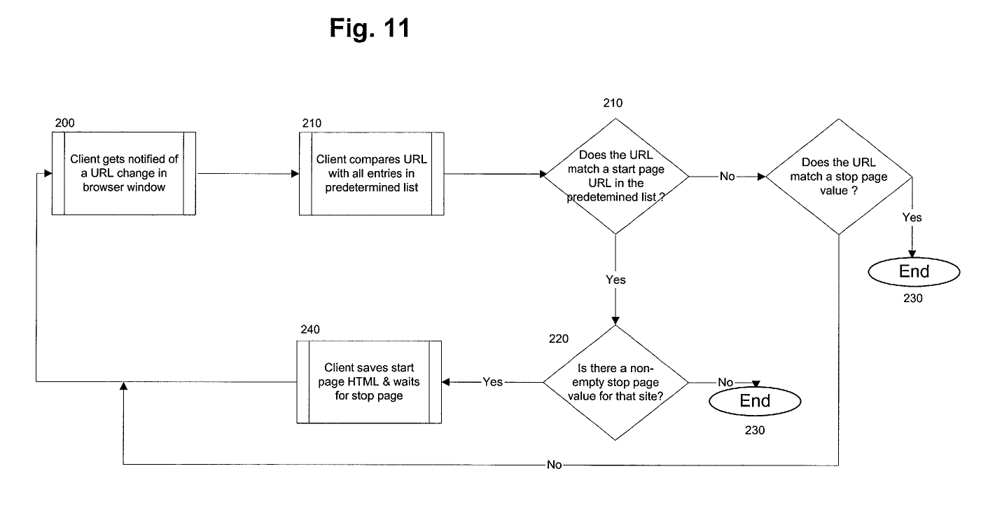

FIG. 10 illustrates an example process for capturing and parsing information from one or more addressed documents according to the present invention. Referring to FIG. 10, a client side component resides on a user computing device such as a personal computer, laptop computer, wireless communication device with processing capability, handheld computer, smart card, or any other device that has computing capability and can connect to an external communication network. A user connects to a location in the network that uses an identifier for addressing or cataloging information, 100. Such an identifier can be a universal resource locator, internetworking address, MAC address in a local network, or other addresses.

The client side component is in communication with a browser or other program or program component on the user computing device that receives and/or transmits the location or site in the network that the user computing device is in communication with. This can be accomplished by implementing the client side component as a JAVA executable code or applet or other program that can detect data from the browser or other program. The client side component then detects or receives an identifier, 110. The client side component then determines if the received or detected identifier matches one or more predetermined identifiers, 120.

If the received identifier does not match one or more predetermined identifiers, the client side component waits for the next received identifier. If the received identifier matches one of the one or more predetermined identifiers, then the user of the user device can be prompted as to whether they want to save information being accessed by the browser, 130. The predetermined information is generally determined by a server or parser component.

If the user responds that the information should be saved, then client component communicates with the browser or other program or program component on the user computing device that receives the information from the network to extract all or most of the information that relates to the specific identifier and transmits that information through the network to the server component, 140. According to specific embodiments of the present invention, the client component transmits information to the server component via an encrypted session. The server component upon receiving the information then parses the information if possible or stores it for later if not possible to presently parse it. The status of the parsed information, e.g. whether it was successfully parsed and when the parsed information will be available to the user, is then sent to the user computing device, 150. The status is then communicated to the user, e.g. by visually displaying a message to this effect, 160.

According to specific embodiments of the present invention, the above process is utilized to capture internet web pages containing purchasing information, wherein those webpages are identified by an identifiable URL. However, the information on the internet web page can have different types of information or tags on it so long as those tags are determined in advance.

FIG. 11 illustrates an example process for determining start and stop pages according to an embodiment of the present invention.

Referring to FIG. 11, the client side component while in communication with the browser or other program or program component is notified of a change in the identifier, 200. The client side component then determines if the identifier corresponds to a start page identifier in the predetermined list of identifiers associated with the client, 210. If the identifier corresponds to a start page identifier in the predetermined list, then the client side component determines if there are other identifiers in the predetermined list associated with current identifier, 220. If there are no associated identifiers, then the client side component ceases saving information from additional pages or documents, 230. If there are additional identifiers, the client side component saves the information associated with the current document or page of the current identifier and waits until all of the associated identifiers have been detected, 240. Once there are no further associated identifiers, then the client side component ceases saving information from additional pages or documents, 230. It is also possible for the purposes of implementation that the only other identifier associated with a start page identifier is a stop page identifier, in this way all of the pages or documents that relate to identifiers that are detected after the start page identifier but before the stop page identifier are captured by the client side component.

The other identifiers that are associated with each other can be identifiers for other addressed documents that relate somehow to a transaction or sequence of related informational the information from which can be utilized. For example, in a transaction, the items purchased may be in one document or page while the price or shipping information may be on another page, while the actual confirmation of the purchase may be on yet another page. In this case several documents need to be captured for all of the proper information to be obtained. Further in the case of interactive tests or games or informational searches information on multiple pages may be required so that all of the requisite information is used.

For simplicity the information by the client side component with respect to each page is all of the information on the document between a predetermined stop and start reference and does not require the client side component to selectively parse the document. For example, if the document is a mark up language document, e.g. HTML, all of the information between <HTML> and </HTML> or <Body> and </Body> can be stored. In other types of documents other identifiers can be used.

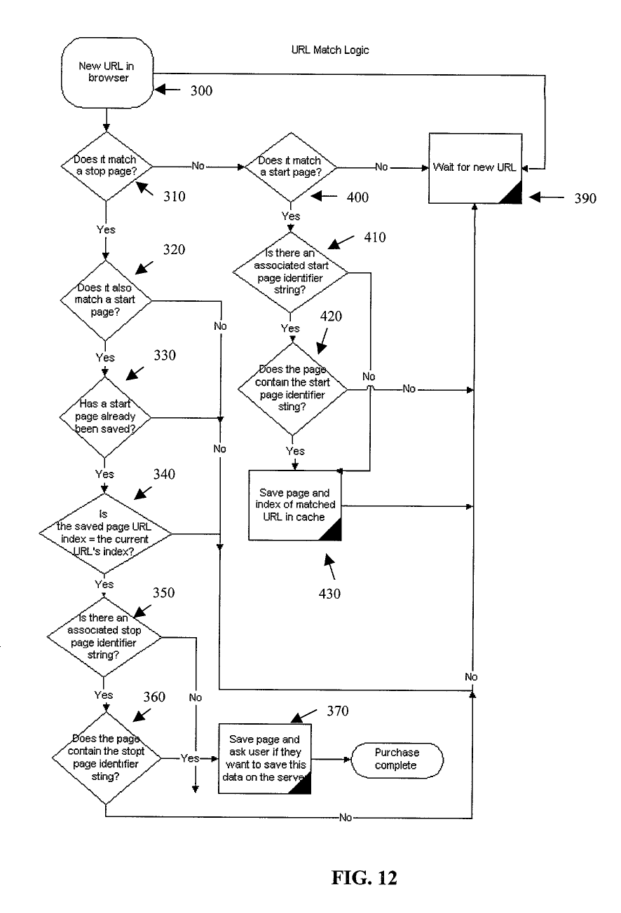

FIG. 12 illustrates an example process for determining whether one or more addressed documents are relevant according to specific embodiments of the present invention.

Referring to FIG. 12, another example process for determining whether a document is of interest is illustrated. The client side component while in communication with the browser or other program or program component is notified of a change in the identifier, 300. The client side component then determines if the identifier corresponds to a stop page identifier in a group of associated identifiers of the predetermined identifiers, 310. If the identifier corresponds to a stop page identifier, the client side component then determines if the identifier also corresponds to a start page identifier in the group of associated identifiers, 320. If the identifier also corresponds to a start page identifier, then the client side component determines if the start page identifier has already been encountered for the current group of associated identifiers, 330. If the start page identifier has already been encountered for the current group of associated identifiers, the client side component then determines whether all of the required identifiers except for the stop page identifier have been encountered for current group of identifiers, 340. In an alternative embodiment, the client side component uses a timer function that times out the saving functionality. If the stop page identifier is the only one that has not been encountered for the current group of associated identifiers, then client side component determines whether there is a predetermined stop page string associated with the stop page identifier for the current group of associated identifiers, 350. If there is, then client side component searches the document for the predetermined stop page string associated with the stop page identifier, 360. If the client component finds the stop page string, the user is prompted as to whether they want to save the information that was collected, e.g. the current transaction, 370. The client side component will then cease saving documents for the current transaction, transmit the saved documents to the server, and wait for the next start page identifier.

If the client side component determination of whether the identifier corresponds to a stop page identifier in a group of associated identifiers, 310, corresponds to a determination that the identifier is not a stop page identifier, the client side component determines if the identifier corresponds to a start page identifier in a group of associated identifiers, 400. If it is not, the client side component will wait for the next identifier, 390. If it is a start page identifier, the client side component determines if there is a predetermined start page string associated with the start page identifier, 410. If there is no predetermined start page string associated with the start page identifier, then the client side component will save the document associated with the start page identifier and will start a local cache for storing documents in a group of identifier associated with the start page identifier, 430. If there is a start page identifier string associated with the start page identifier, then the client side component searches the document for the predetermined start page string associated with the start page identifier, 420. If the start page string is found in the document, then the client side component will save the document associated with the start page identifier and will start a local cache for storing documents in a group of identifier associated with the start page identifier, 430. If the start page string is not found in the document, the client side component will wait for the next identifier, 390.

According to specific embodiments of the present invention when working with mark language documents, like HTML, the start and stop page strings contain both a tag string identifier portion corresponding to a tag and a content string identifier portion corresponding to alphanumeric information. It is also possible that an only a tag string identifier or a content string identifier be used. In addition, if unique digital keys, digital watermarks, codes or other unique content are contained in a start page or stop page these can also be used as start page or stop page strings.

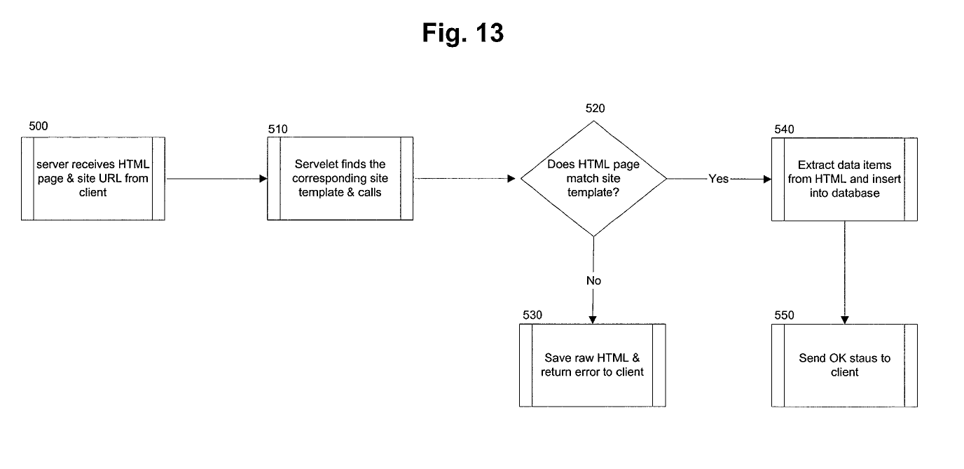

FIG. 13 illustrates an example process for parsing according to specific embodiments of the present invention. Referring to FIG. 13, once a document is transmitted from the client side component to the server side component, the server side component will parse the relevant information from the document, 500. According to specific embodiments of the present invention, documents are generally sent with its saved content and associated identifier. The server component then finds the template associated with the identifier of the document, 510. The templates for parsing separate pages generally are created prior to receipt of documents so that the position and tags required for parsing are known.

If the document is an HTML document then as one example it is typical that the template is an XML template. The determination of the associated template to the document is done by matching a predetermined identifier and string with the identifier and content of the document. As described above with the respect to FIG. 12, the string can be a tag string, content string, tag and content string, digital key, digital watermark, or any other predetermined code or content.

The template contains various tags and positioning information in the document of those tags. The positioning information is presently preferred to be set up so that the position of each tag is described with respect to one other tag, and specifically the tag before it in the template. Further, for ease of processing, it is preferred that position of the tag is described with respect to an immediately prior tag in the data stream.

The server side component then will parse the document by searching for the tags in the template in the document, 520. If all of the tags are not found then the system will save the entire document and error information as to the missing tags can be returned to the user, 530. If all of the tags are found then the alphanumeric information is extracted and inserted to appropriate fields in the server side database, 540. Once the alphanumeric information is extracted and inserted to appropriate fields in the server side database a message indicating a successful data capture is sent to the client side component, 550.

Adding a Page by User Action

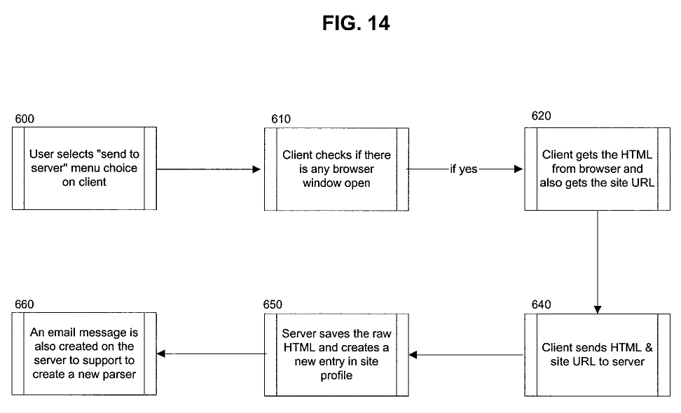

The present invention also allows a user to indicate a document or group of documents as a document of interest for parsing at the server site. Referring to FIG. 14, a user inputs a command into the client side component indicating that the user wants to create a group of associated documents from which information is to be parsed, 600. The client side component determines if a browser or other program or program component on the user computing device is running or in operation, 610. The client side component then stores the information or document and its associated identifier in the browser or other program or program component on the user computing device, 620. The client side component then sends the information or document and its associated identifier to the server side component, 630. The server side component then will determine that no identifier corresponds to the identifier received and will create a new entry in its table of identifiers, 640. The server side component then will prompt the system administrator of the server to create a template for this document, 650. This template can be created either by a human designer, by template design logic running on a computer system, or by both a human designer using or reviewing template design logic running on a computer system.

In addition, while the URLs are stored in the user computing device and accessible by the client side component, the server side component can maintain a master list, in one or more categories, of URLs that are to be captured by the client side component. The master list can then be transmitted to all or a selected of client side components using known auto update or other method, so that any addition by one user of a client side component can be propagated to the other appropriate client side components.

Embodiment in a Programmed Digital Apparatus

As will be understood in the art, aspects of the present invention may be embodied on a fixed media or as a transmittable program component containing instructions and/or data that when loaded into an appropriately configured computing device will cause that device to perform according to the invention.

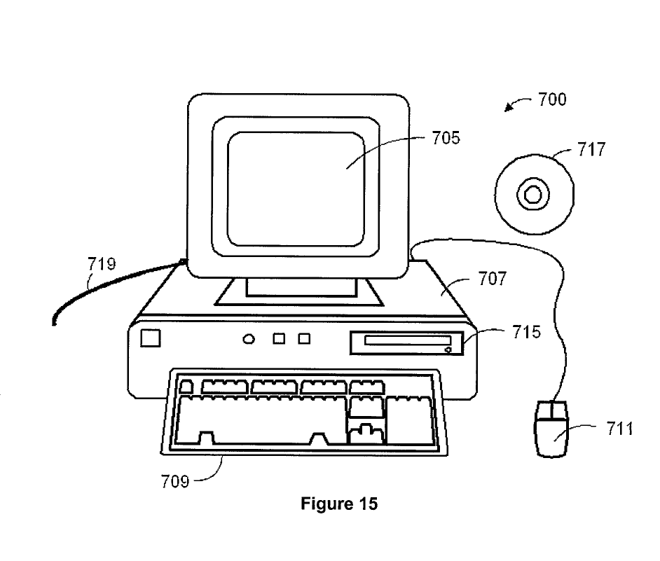

FIG. 15 illustrates an example logic processing device, components of which may embody various aspects of the present invention. FIG. 15 illustrates digital device 700 that may be understood as a logical apparatus that can read instructions from media 717 and/or network port 719. Apparatus 700 can thereafter use those instructions to direct a method or system according to the invention. One type of logical apparatus that may embody the invention is a computer system as illustrated in 700, containing CPU 707, optional input devices 709 and 711, disk drives 715 and optional monitor 705. Fixed media 717 may be used to program such a system and could represent a disk-type optical or magnetic media or a memory and the invention may be embodied as instructions on fixed media 717. Communication port 719 may also be used to program such a system and could represent any type of communication connection.

The invention also may be embodied within the circuitry of an application specific integrated circuit (ASIC) or a programmable logic device (PLD). In such a case, the invention may be embodied in a computer understandable descriptor language which may be used to create an ASIC or PLD that operates as herein described. The invention also may be embodied within the circuitry or logic processes of other digital apparatus.

Conclusion

The invention has now been explained with regard to specific embodiments. Variations on these embodiments and other embodiments will be apparent to those of skill in the art. The invention therefore should not be limited except as provided in the attached claims. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method for collecting usage information between buyers and sellers on a network comprising:
detecting an ordering action by a buyer;
activating a buyer logic module to perform a buyer desired action, wherein said buyer desired action comprises capturing of order data; and
forwarding said order data to a server.

2. The method of claim 1 wherein said buyer desired action comprises capturing order data and translating for input into a financial application and the method further comprising translating, at the server, download data for import into a financial application wherein said financial application is a buyer selected financial application.

3. The method of claim 1 wherein said buyer logic module comprises a plug-in application capable of running in cooperation with a standard browser.

4. The method of claim 1 further comprising:
collecting ordering data for a particular buyer at said aggregator; and
downloading data to said user for a range of dates when requested by said user.

5. The method of claim 4 further comprising translating, at the server, download data for import into a financial application wherein said financial application is a buyer selected financial application.

6. The method of claim 1 wherein activating the buyer logic module to capture order data comprises saving at least two documents each containing some of the order data and the method further comprising parsing from each of the at least two documents information corresponding to some of the order data to capture the order data.

7. The method of claim 6 wherein saving at least two documents each containing some of the order data comprises determining whether one of the at least two documents comprises a start page.

8. The method of claim 7 further comprising determining whether one of the at least two documents comprises a stop page.

9. The method of claim 8 wherein determining whether one of the at least two documents comprises a start page comprises determining whether an identifier for one of the at least two documents is substantially the same as a predetermined start page identifier and determining whether an identifier for one of the at least two documents is substantially the same as a predetermined stop page identifier.

10. The method of claim 9 wherein determining whether one of the at least two documents comprises a start page comprises determining whether an identifier for one of the at least two documents is substantially the same as a predetermined start page identifier and whether information contained in the one document is substantially the same as predetermined start page information.

11. The method of claim 6 wherein parsing from each of the at least two documents information corresponding to some of the order data to capture the order data comprises for each of the at least two documents selecting information on the document based upon a predetermined position of the information in the document with respect to other predetermined information to be selected.

12. A method for automated ordering comprising:
from a local computer device connecting via a public network to a procurement site to place an on-line order;
capturing raw data from said procurement site related to information regarding the on-line order, the information corresponding to each item purchased along with the price of that item; and
transmitting the raw data to a data converter server.

13. The method of claim 12 further comprising:
at said data converter, converting data to a format acceptable to a financial application;
transferring converted data to said local computer device; and
making converted data available to said financial application.

14. The method of claim 12 further comprising:
if said procurement site is not preconfigured to operate with said data converter, first transmitting raw data to said local computer device to then be transmitted to said data converter.

15. The method of claim 12 wherein capturing raw data from said procurement site comprises capturing at least two documents from the procurement site that comprises the information regarding the on-line order.

16. The method of claim 12 wherein capturing the at least two documents comprises determining which documents to capture by comparing the uniform resource locators for multiple documents with predetermined uniform resource locators.

17. The method of claim 12 wherein capturing the at least two documents further comprises comparing information in the documents to predetermined information.

18. A method for automating ordering items from a website comprising:
from a local computer system, connecting via a public network to a shopping site and placing an order;
from a client at said local computer system detecting data indicating an order;
requesting user confirmation for automated processing of transaction;
determining if a template exists for said shopping site and if yes:
transferring template format to client at said local computer system;
parsing order data into fields using template;
requesting user confirmation that mapping is correct; and
creating an XML document.

19. The method of claim 16 further comprising
creating accounting import file for user's financial application; and
importing data into financial application.
